(19) United States
(12) Patent Application Publication
(10) Pub. No.: US 2008/0114726 A1
(43) Pub. Date: May 15, 2008

(54) METHOD TO QUERY CELL PHONES FOR PICTURES OF AN EVENT

(75) Inventors: Susann M. Keohane, Austin, TX (US); Gerald F. McBrearty, Austin, TX (US); Jessica C. Murillo, Round Rock, TX (US); Johnny Meng-Han Shieh, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/558,134

(22) Filed: Nov. 9, 2006

(51) Int. Cl. G06F 7/10; G06F 17/30

(52) U.S. Cl. 707/3; 707/E17.014

(57) ABSTRACT

A method for retrieving image data includes: inputting a query for image data into a communications infrastructure; communicating the query to a plurality of communications devices, the plurality of communications devices providing the image data to the communications infrastructure; and retrieving the image data from the communications infrastructure. A system and a computer program product for implementing the method are provided.

### BACKGROUND OF THE INVENTION

1. Field of the Invention

The invention herein relates to a plurality of communications devices, and in particular, to querying the plurality for pictures.

2. Description of the Related Arts

Often times, such as after a disaster such as a bombing or a kidnapping, the authorities must collect all of the pictures form public surveillance cameras through out a city to collect evidence. Likewise, the authorities must wait for individuals to look at the pictures that they took that day to identify relevant images. Advantageously, with the growth of electronic technologies, such as cellular telephones with cameras, many individuals collect images that are useful for determining aspects of an event.

What are needed are techniques for collecting images from cell phones from a central location.

### SUMMARY OF THE INVENTION

The shortcomings of the prior art are overcome and additional advantages are provided through the provision of a method for retrieving image data, the method including: inputting a query for image data into a communications infrastructure; communicating the query to a plurality of communications devices, the plurality of communications devices providing the image data to the communications infrastructure; and retrieving the image data from the communications infrastructure.

Also disclosed is system for retrieving image data, the system including: a communications infrastructure for communicating a query for image data to a plurality of communications devices, the plurality of communications devices providing the image data to the communications infrastructure; and storage for receiving the image data from the communications infrastructure.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product stored on machine readable media, the product providing instructions for one of manually retrieving and automatically retrieving image data, the instructions including instructions for: inputting a query for image data into a communications infrastructure accessing the infrastructure by one of a personal access and an operator access; communicating the query to a plurality of communications devices, the plurality of communications devices providing the image data to the communications infrastructure; wherein the communicating includes issuing at least one instruction for capturing the image data; and retrieving at least one of a still picture and a video image as the image data from the communications infrastructure; wherein the retrieving is controlled by implementing an authorization level.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a communications infrastructure;

FIG. 2 illustrates submission of a query and providing a query result; and

FIG. 3 illustrates a method for performing the query submission.

The detailed description explains the preferred embodiments of the invention, together with advantages and features, by way of example with reference to the drawings.

### DETAILED DESCRIPTION OF THE INVENTION

The teachings herein provide a system, method and apparatus for performing queries of a plurality of communications devices. In typical embodiments, the communications devices are cellular telephones (also referred to as “cell phones”) and include a camera (picture taking capabilities). A query is typically initiated through a central location, such as an operator of a communications infrastructure, or by a law enforcement authority.

The query may perform any one or more of a number of tasks. For example, the query may issue commands to users, interrogate the plurality of devices for information, collect information from the plurality of devices (directly or indirectly), initiate actions of the plurality of devices and others. Other aspects of the teachings herein will become more apparent when considering the disclosure as a whole.

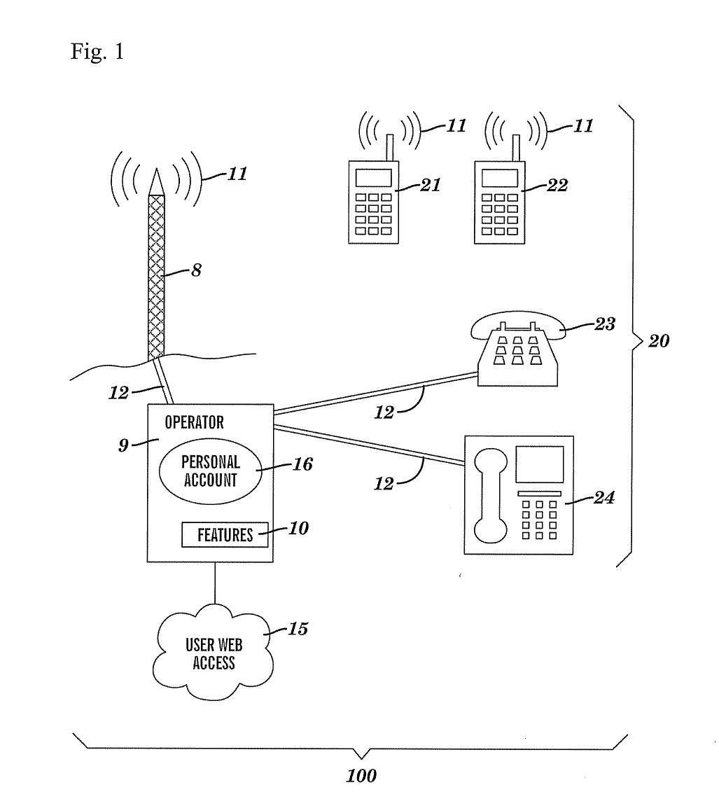

Referring to FIG. 1, aspects of an exemplary communications infrastructure 100 are shown. The communications infrastructure 100 depicted herein includes a plurality of communications devices 20. Exemplary communications devices 20 include mobile stations, such as a cellular telephone 21 (referred to as a “cell phone 21), a satellite telephone 22, and a walkie-talkie (radiotelephone or radio—not shown). Typically, the mobiles stations communicate with the communications infrastructure 100 by use of a radio signal 11 produced by a radio tower 8. Other communications devices 20 include fixed stations such as and without limitation, a home telephone 23 and a business telephone 24. Typically, the fixed stations communicate with the communications infrastructure 100 by use of communications lines 12.

In the embodiments discussed herein, the communications devices 20 include picture capabilities. That is, for example, each cell phone 21 includes a camera, such as a charge-coupled-device (CCD). As another example, the business telephone 24 includes a camera as may be used in closed circuit conferencing. In further embodiments, at least some of the communications devices 20 include location information (such as may be derived from internal global positioning receivers (GPS)).

In typical embodiments, the communications infrastructure 100 is managed by an operator 9. As used herein, the operator 9 includes all resources necessary for operating and maintaining the communications infrastructure 100. Exemplary components, generally not depicted herein (for purposes of simplicity), include, without limitation: computers and components thereof, power supplies, personnel, communications networks, etc. As examples of components of the operator 9, the communications lines 12 as well as the radio signal 11 are used to connect a base station (not shown) of the operator 9 with the various communications devices 20.

In some embodiments, users are provided access to and control over a personal account 16 maintained by the operator 9. Exemplary types of access include user web access 15 available through the Internet.

In typical embodiments, the operator 9 maintains voice mail and/or other account resources for each user. Exemplary account resources include storage, such as may be used for storing of data (such as pictures, graphics and other data files).

The communications infrastructure may include any one or more of a cellular network, a fixed network, a private network (such as a corporate network), or any other type of communications infrastructure 100.

A query feature 10 for the communications infrastructure 100, as disclosed herein, may be implemented through various techniques. For example, the query feature 10 may be implemented as software including machine readable instructions stored as a computer program product. The computer program product, or software, may be stored using any one or more of a variety of media. Non-limiting examples of media include, magnetic media, optical media, magneto-optical media, read-only memory (ROM), random-access memory (RAM), a flash memory, a hard drive, a tape drive and others. Typically, the storage is a part of the operator 9. However, in some embodiments, the storage may be included, at least in part within each of the communications devices 20. In one embodiment, at least a portion of the query feature 10 is manually implemented by call center personnel.

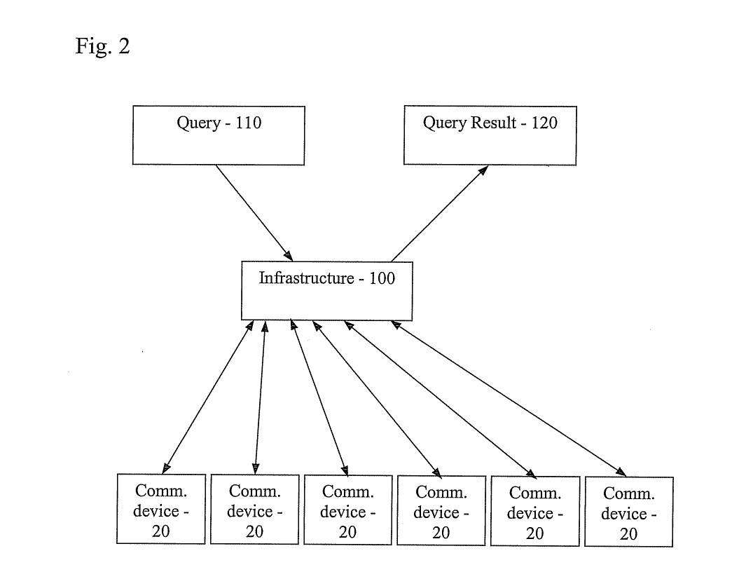

The query feature 10 provides for a user, system operator, governmental official or other such entity to perform a query of the plurality of communications devices 20. As shown in FIG. 2, the query 110 is input into the communications infrastructure 100. The infrastructure 100 executes aspects of the query 110 as appropriate and returns a query result 120.

The query 110 may include a request for picture data from each of the communications devices 20. The request may execute automatically (e.g., in the background) and not require input or cognizance of a user of the respective device 20. In some embodiments, permission for uploading to the operator is granted by a user of the respective device 20 prior to any data transmission. In further embodiments, the query 110 includes instructions which are downloaded to each of the communications devices 20. Exemplary instructions include instructions for automated actuation of camera components, etc, . . . .

The query 110 may include multiple filters. For example, the query 110 may be input into the infrastructure 100, which in turn identifies candidate devices 20 by, for example, location. Once the devices 20 in or nearby a certain location are identified, the query 110 is issued to those selected devices 20. Location may be determined using techniques known to those skilled in the art, such as, for example, by use of system triangulation or GPS signal data.

Query results 120 may be returned with a variety of ancillary information. Ancillary information may include, for example, location data, time data, date data, sequence data, corresponding communications device identification data and other such data.

Privacy concerns may be addressed by implementing various levels of authorization. For example, an owner of the cell phone 21 could turn off automatic download, notification, and even opt out of the query feature 10. Accordingly, one skilled in the art will recognize that the query feature 10 may include instructions for implementation by various components of the infrastructure 100. For example, some instructions may be resident within the communications device 20, while other instructions are resident in the resources of the operator 9.

Further, the query feature 10 may be implemented for capturing of video as well as still pictures. These and other image data are within the contemplation of the teachings herein. Further examples include images that have been ported to the communications device from another device 20, such as a separate digital camera.

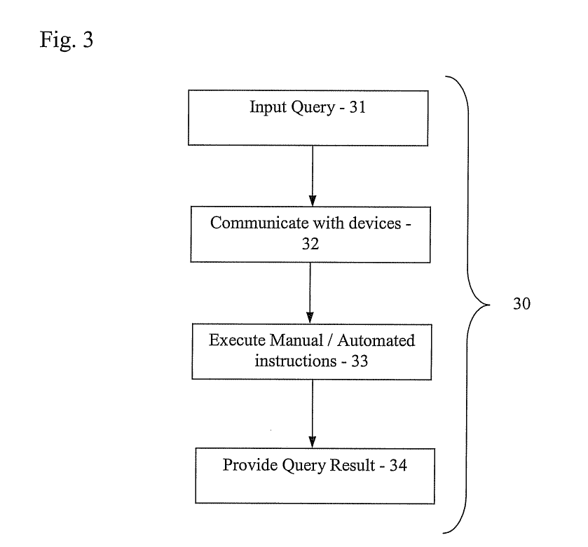

FIG. 3 depicts an exemplary method for implementing the query feature 10. In the query method 30, the user inputs the query 31. The infrastructure 100 then communicates with the devices 32. At least one of manual and automatic execution 33 takes place. In a last step, the method 30 provides for returning the query result 34.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for retrieving image data, the method comprising:
inputting a query for image data into a communications infrastructure;
communicating the query to a plurality of communications devices, the plurality of communications devices providing the image data to the communications infrastructure; and
retrieving the image data from the communications infrastructure.

2. The method as in claim 1, wherein the inputting comprises accessing the infrastructure by one of a personal access and an operator access.

3. The method as in claim 1, wherein retrieving the image data comprises retrieving at least one of a still picture and a video image.

4. The method as in claim 1, wherein the retrieving comprises at least one of manually retrieving and automatically retrieving.

5. The method as in claim 1, wherein the communicating comprises issuing at least one instruction for capturing the image data.

6. The method as in claim 1, further comprising controlling the retrieving by implementing an authorization level.

7. The method as in claim 1, further comprising controlling an authorization level for the retrieving.

8. A system for retrieving image data, the system comprising:
a communications infrastructure for communicating a query for image data to a plurality of communications devices, the plurality of communications devices providing the image data to the communications infrastructure; and storage for receiving the image data from the communications infrastructure.

9. The system as in claim 8, wherein the plurality of communications devices comprises at least one of a mobile station, a cellular telephone, a walkie-talkie, a satellite telephone, a fixed station, a home telephone, and a business telephone.

10. The system as in claim 8, wherein the image data comprises at least one of a still picture and a video image.

11. The system as in claim 8, wherein the communications infrastructure comprises a wireless system operator.

12. The system as in claim 8, wherein at least one communications device comprises a camera for capturing the image data.

13. The system as in claim 8, wherein the image data comprises ancillary data.

14. The system as in claim 13, wherein the ancillary data comprises at least one of location data, time data, date data, sequence data and corresponding communications device identification data.

15. A computer program product stored on machine readable media, the product providing instructions for one of manually retrieving and automatically retrieving image data, the instructions comprising instructions for:
inputting a query for image data into a communications infrastructure accessing the infrastructure by one of a personal access and an operator access;
communicating the query to a plurality of communications devices, the plurality of communications devices providing the image data to the communications infrastructure; wherein the communicating comprises issuing at least one instruction for capturing the image data; and
retrieving at least one of a still picture and a video image as the image data from the communications infrastructure; wherein the retrieving is controlled by implementing an authorization level.
